(19) United States
(12) Patent Application Publication
(10) Pub. No.: US 2026/0090942 A1
(43) Pub. Date: Apr. 2, 2026

(54) ROLLATOR

(71) Applicant: SHENZHEN ASPIRED TECHNOLOGY CO., LTD, Shenzhen (CN)

(72) Inventor: Yongwei WANG, Shenzhen (CN)

(21) Appl. No.: 19/378,412

(22) Filed: Nov. 4, 2025

Related U.S. Application Data
(63) Continuation of application No. PCT/CN2024/096063, filed on May 29, 2024.

(30) Foreign Application Priority Data
Aug. 16, 2023 (CN) 202322217420.2

(51) Int. Cl. A61H 3/04

(52) U.S. Cl. CPC A61H 3/04; A61H 2201/0161; A61H 2201/0192; A61H 2201/1626; A61H 2201/1638; A61H 2201/1642

(57) ABSTRACT

A rollator comprising a frame body, pedal assemblies, a backrest assembly, and a seat assembly. The frame body comprises a first frame, a second frame, and a connecting frame; the seat assembly is arranged on the connecting frame; the first frame is connected to the second frame by means of the connecting frame and can be folded towards the second frame; the pedal assemblies are rotatably connected or detachably mounted on the first frame and the second frame and are located below the connecting frame; the backrest assembly is rotatably connected or detachably mounted on the first frame and the second frame and are located above the connecting frame.

### CROSS-REFERENCE TO RELATED APPLICATIONS

This application is a continuation of International Application No. PCT/CN2024/096063, filed on May 29, 2024, which is based upon and claims priority to Chinese Patent Application No. CN202322217420.2, filed on Aug. 16, 2023. The entire contents of the above-referenced applications are hereby incorporated by reference.

### TECHNICAL FIELD

The present application relates to the field of rollator technology, particularly to a rollator.

### BACKGROUND

The devices that assist the human body in supporting weight, maintaining balance, and walking, are called rollators, and the people with limited mobility, such as the elderly or injured, can use assistive devices to assist walking; However, the handrail tube of existing rollators is fixed on the frame, unable to adjust the angle, let alone switching the rollator's use state, such that existing rollators are not flexible enough and have a relatively single function.

### SUMMARY

The present application provides a rollator that can adjust the use state of the first handrail and second handrail, for example, between the first and second inclined states, to assist the user in supporting or pushing.

The present application provides a rollator comprising a frame body, a foot pedal assembly, a backrest assembly, and a seat cushion assembly; the frame body comprises a first frame, a second frame, and a connecting frame, the seat cushion assembly is disposed on the connecting frame, the first frame is connected to the second frame through the connecting frame and is folded towards the second frame, the foot pedal assembly is rotatably connected or detachably installed on the first frame and the second frame, and is below the connecting frame, and the backrest assembly is rotatably connected or detachably installed on the first frame and the second frame, and is above the connecting frame;

The first frame is rotatably connected with a first handrail tube, and the second frame is rotatably connected with a second handrail tube, both the first handrail tube and the second handrail tube have a first inclined state in which a first angle is formed with a support surface on which the frame is placed, and a second inclined state in which a second angle is formed with a support surface, the first angle is within the range of 80°-90°, and the second angle is within the range of 65°-75°.

In the rollator of the first embodiment of the present application, the connecting frame includes a first cross bar and a second cross bar that are arranged crosswise and rotate relative to each other at the crosswise position, one end of the first cross bar and the second cross bar is connected to the first frame, the other end of the first cross bar and the second cross bar is connected to the second frame, and the two ends of the seat cushion assembly are connected to the first cross bar and the second cross bar, respectively.

In the rollator of the first embodiment of the present application, the first frame includes a first support rod having a first roller member, the second frame includes a second support rod having a second roller member, the first handrail tube is rotatably connected to the middle of the first support rod, and the second handrail tube is rotatably connected to the middle of the second support rod.

In the rollator of the first embodiment of the present application, the first frame has a first adjusting member connecting to the first handrail tube for switching the first handrail tube, when operated, between a first inclined state and a second inclined state; and/or,
the second frame has a second adjusting member connecting to the second handrail tube for switching the second handrail tube, when operated, between the first inclined state and the second inclined state.

In the rollator of the first embodiment of the present application, the first frame includes a first spacer rod that is spaced apart from the first support rod along a height direction of the first frame, and the first handrail tube is movably connected to the first spacer rod through the first adjusting member; and/or,
the second frame includes a second spacer rod that is spaced apart from the second support rod along a height direction of the first frame, and the second handrail tube is movably connected to the second spacer rod through the second adjusting member.

In the rollator of the first embodiment of the present application, the first and second adjusting members have a first adjustment position and a second adjustment position, and when the first handrail tubes and second handrail tube are fixed in the first adjustment position, the first handrail tubes and second handrail tube are in a first inclined state; when the first handrail tube and the second handrail tube are fixed in the second adjustment position, the first handrail tube and the second handrail tube are in a second inclined state.

In the rollator of the first embodiment of the present application, the first and second adjusting members include a connection structure connecting to the first spacer rod and second spacer rod, the connection structure has the first adjustment position and second adjustment position that communicate with each other and form an adjustment track, and a limiting member is connected between the adjustment track and the first handrail tubes and second handrail tube to restrict the first handrail tubes and second handrail tube to the first or second adjustment positions; or,
the first adjusting member and second adjusting member include a telescopic rod, one end of the telescopic rod is connected to the first spacer rod and second spacer rod, a sliding sleeve structure is provided between the telescopic end of the telescopic rod and the first handrail tube and second handrail tube, and the sliding sleeve structure slides along a length direction of the first handrail tube and second handrail tube under the action of the telescopic rod.

In the rollator of the first embodiment of the present application, the first adjusting member and second adjusting member include a rotating table connecting to the first support rod and second support rod, the rotating table has a rotating track, and the first handrail tube and second handrail tube are rotatably connected to the rotating table and move along the rotating track; and/or,
the first adjusting member and second adjusting member include a telescopic tube, one end of the telescopic tube is movably connected to the first handrail tube and second handrail tube, and the other end of the telescopic tube is movably connected to the first support rod and second support rod and has a preset distance greater than zero from the pivot point of the first handrail tube and second handrail tube.

In the rollator of the first embodiment of the present application, the first frame includes a first connecting rod spaced apart from the first spacer rod in a height direction, the second frame includes a second connecting rod spaced apart from the second spacer rod in a height direction, and the backrest assembly is rotatably connected between the first connecting rod and the second connecting rod.

In the rollator of the first embodiment of the present application, the first roller member includes a first front wheel and a first rear wheel, the first front wheel and the first rear wheel are respectively arranged at the two ends of the first support rod, and the diameter of the first rear wheel is greater than or equal to that of the first front wheel; and/or,
the second roller member includes a second front wheel and a second rear wheel, the second front wheel and second rear wheel are respectively arranged at the two ends of the second support rod, and the diameter of the second rear wheel is greater than or equal to that of the second front wheel.

The technical solution provided by the embodiments of the present application may include the following beneficial effects: the present application designs a rollator, comprising a frame, a foot pedal assembly, and a seat cushion assembly, the frame is rotatably connected with a first handrail tube and a second handrail tube, so that the first handrail tube and the second handrail tube can, relative to the frame, switch and be fixed in the first inclined state and the second inclined state, such that the rollator has different use states to meet the various needs of users, make users feel comfortable and satisfied and operate the first handrail tube and the second handrail tube more conveniently, thereby improving the user experience.

It should be understood that the above general description and the subsequent detailed description are only exemplary and explanatory, and cannot limit the present application.

### BRIEF DESCRIPTION OF THE DRAWINGS

In order to more clearly illustrate the technical solution of the embodiments of the present application, a brief introduction will be given to the accompanying drawings required for the description of the embodiments. Obviously, the accompanying drawings described below are some embodiments of the present application. those of ordinary skill in the art can obtain other drawings based on these drawings without creative work.

FIG. 1 is a structural diagram of the rollator provided in an embodiment of the present application;

FIG. 2 is a structural diagram of the rollator in FIG. 1 from another angle;

FIG. 3 is a schematic diagram of the rollator in FIG. 2 in another state;

FIG. 4 is an exploded schematic diagram of the rollator shown in FIG. 1;

FIG. 5 is a structural diagram of the foot pedal assembly in FIG. 1;

FIG. 6 is an exploded schematic diagram of the foot pedal assembly in FIG. 1;

FIG. 7 is a structural diagram of the seat cushion assembly in FIG. 1;

FIG. 8 is a structural diagram of the frame in FIG. 1;

FIG. 9 is an exploded schematic diagram of the structure in FIG. 1;

FIG. 10 is a schematic diagram of the seat cushion and connecting frame in FIG. 1;

FIG. 11 is an exploded schematic diagram of the connection frame in FIG. 1;

FIG. 12 is an exploded schematic diagram of the backrest in FIG. 1;

FIG. 13 is a structural diagram of the first frame in FIG. 1;

FIG. 14 is a structural diagram of the second frame in FIG. 1;

FIG. 15 is a partial schematic diagram of the second frame in FIG. 1;

FIG. 16 is an exploded schematic diagram of the second handrail tube in FIG. 1;

FIG. 17 is a structural diagram of the connection structure in FIG. 1;

FIG. 18 shows structure I of the rollator in one of its states provided in the present application;

FIG. 19 shows structure I of the rollator in another state provided in the present application;

FIG. 20 shows structure II of the rollator in one of its states provided in the present application;

FIG. 21 shows structure II of the rollator in another state provided in the present application;

FIG. 22 shows structure III of the rollator in one of its states provided in the present application;

FIG. 23 shows structure III of the rollator in another state provided in the present application;

FIG. 24 shows structure IV of the rollator in one of its states provided in the present application;

FIG. 25 shows structure IV of the rollator in another state provided in the present application;

FIG. 26 shows structure V of the rollator in one of its states provided in the present application;

FIG. 27 shows structure V of the rollator in another state provided in the present application.

### DETAILED DESCRIPTION OF THE EMBODIMENTS

The technical solutions in the embodiments of the present invention will be described clearly and completely in conjunction with the accompanying drawings of the embodiments of the present invention. Obviously, the described embodiments are only a part of the embodiments of the present invention, rather than all the embodiments. Based on the embodiments of the present invention, all other embodiments obtained by those of ordinary skill in the art without creative work shall fall within the protection scope of the present invention.

It should be understood that the terms used in the present application specification are only for the purpose of describing specific embodiments and are not intended to limit the present application. It should be understood that the directional or positional relationships indicated by the terms “center”, “vertical”, “horizontal”, “length”, “width”, “thickness”, “up”, “down”, “front”, “back”, “left”, “right”, “vertical”, “horizontal”, “top”, “bottom”, “inside”, “outside”, “clockwise”, and “counterclockwise” are based on those shown in the accompanying drawings, and are only for the convenience of describing the present application and simplifying the description, rather than indicating or implying that the device or component referred to must have a specific orientation, and must be constructed and operated in a specific orientation, and therefore they cannot be understood as a limitation to the present application. In addition, the terms “first” and “second” are only used for descriptive purposes and cannot be understood as indicating or implying relative importance or implying the number of technical features indicated. Thus, the features limited to “first” and “second” may explicitly or implicitly include one or more of these features. In the description of the present application, unless otherwise specified, the meaning of “a plurality of” refers to two or more.

Some embodiments of the present application will be described below in detail with reference to the accompanying drawings. In non-conflicting situations, the following embodiments and their features can be combined with each other.

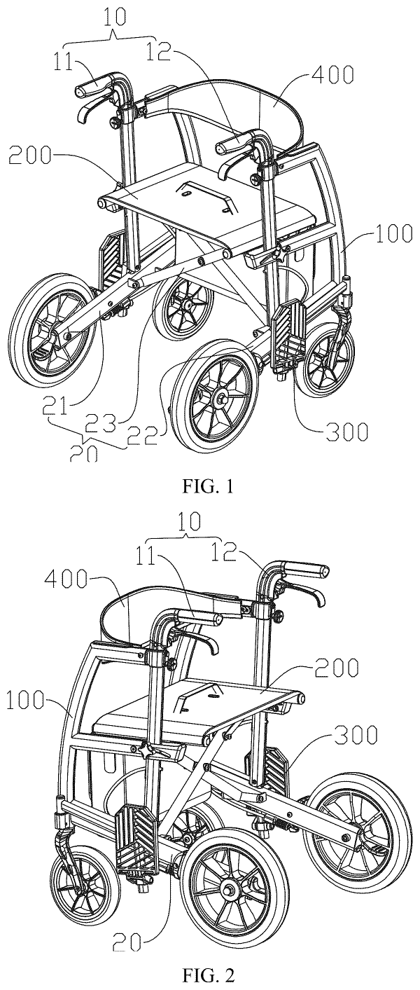

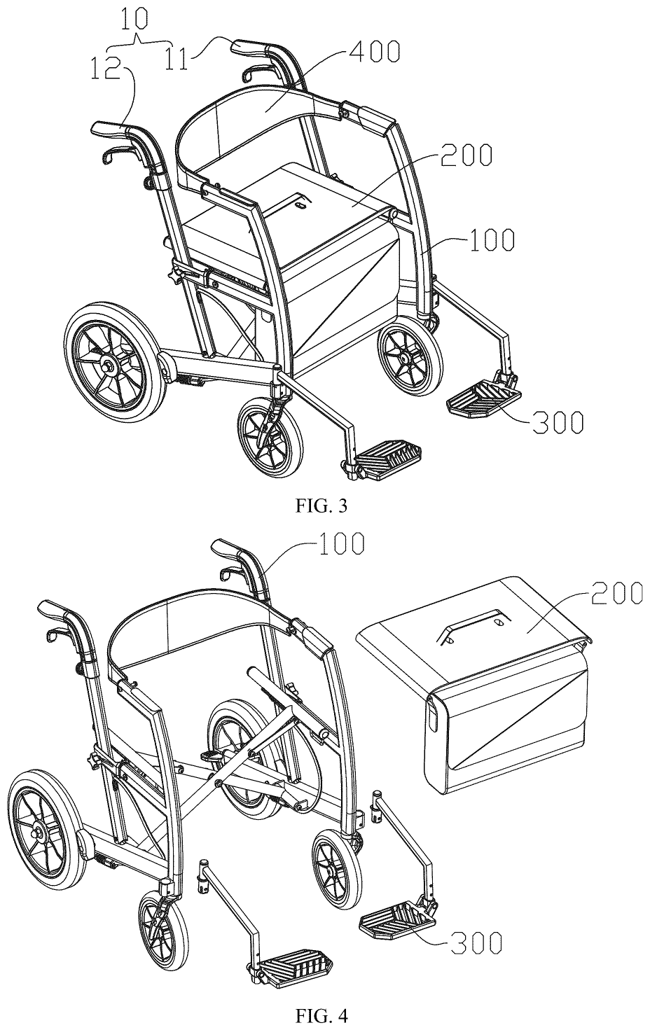

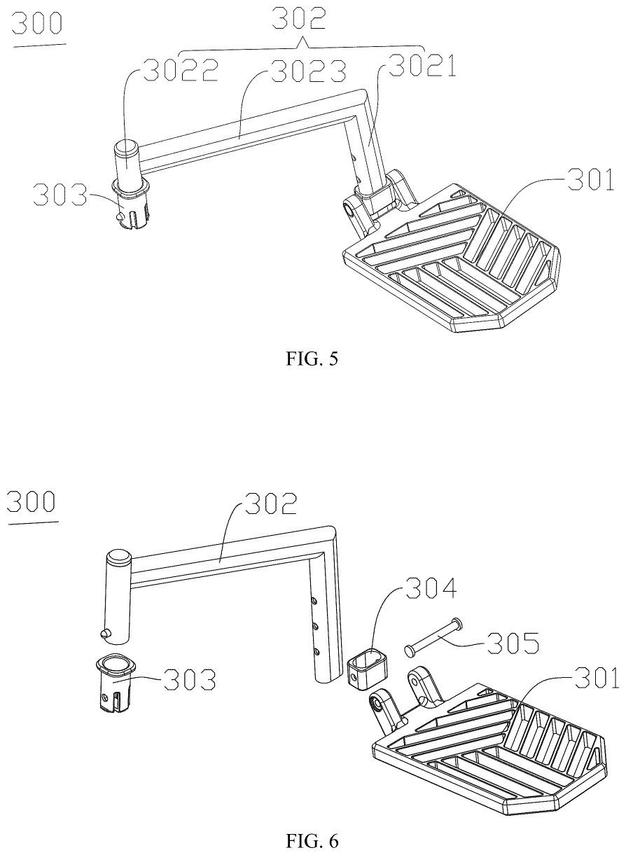

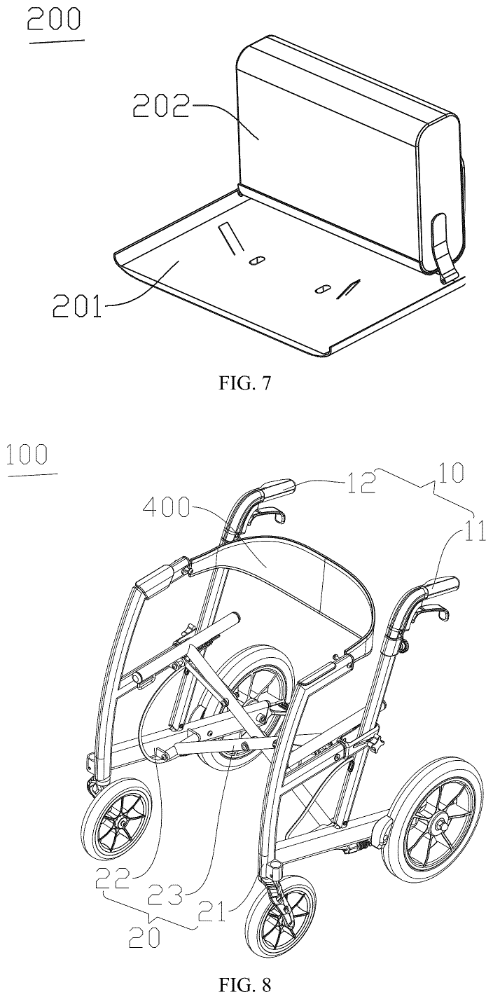

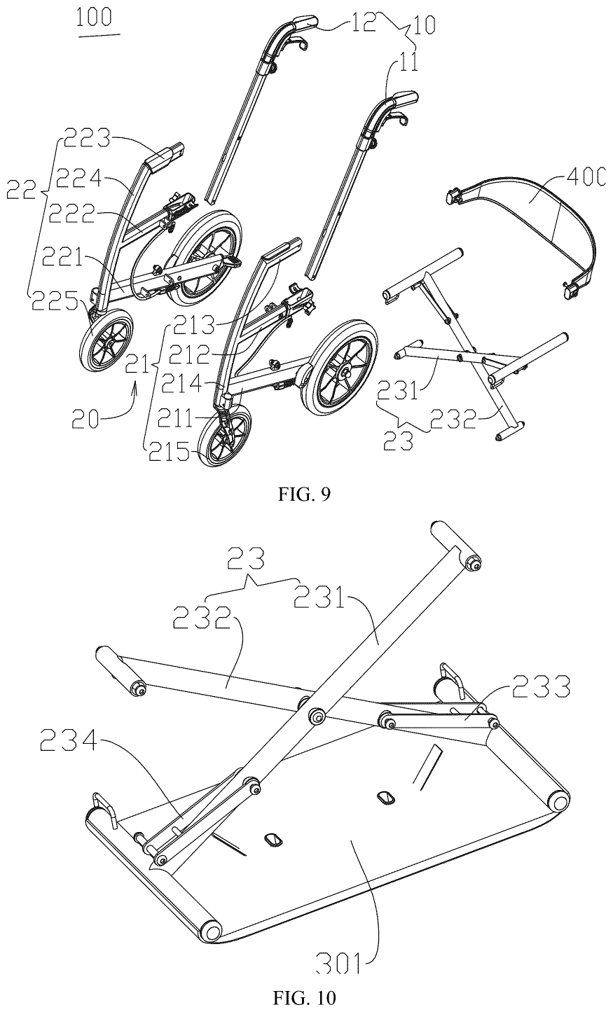

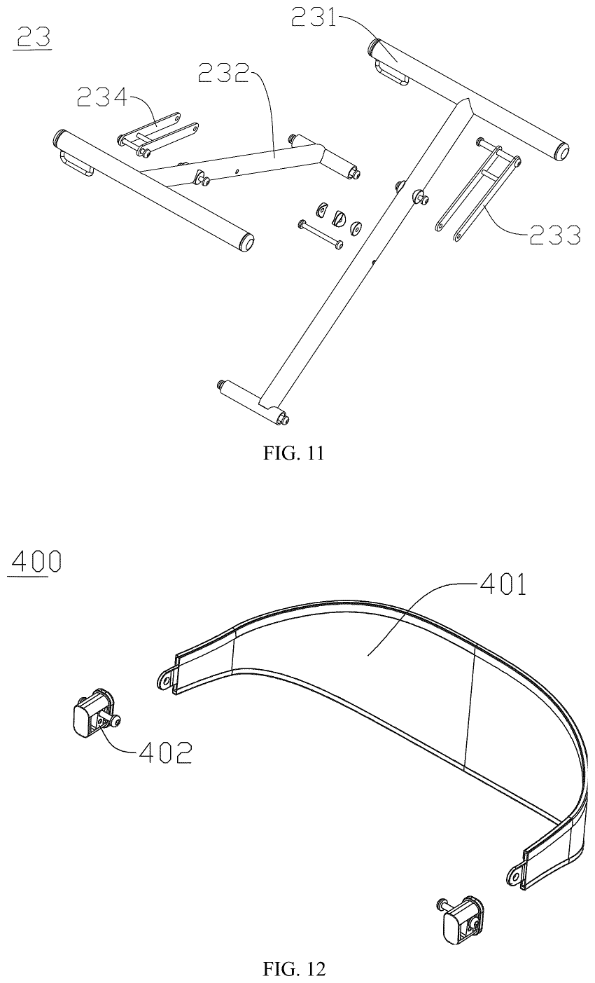

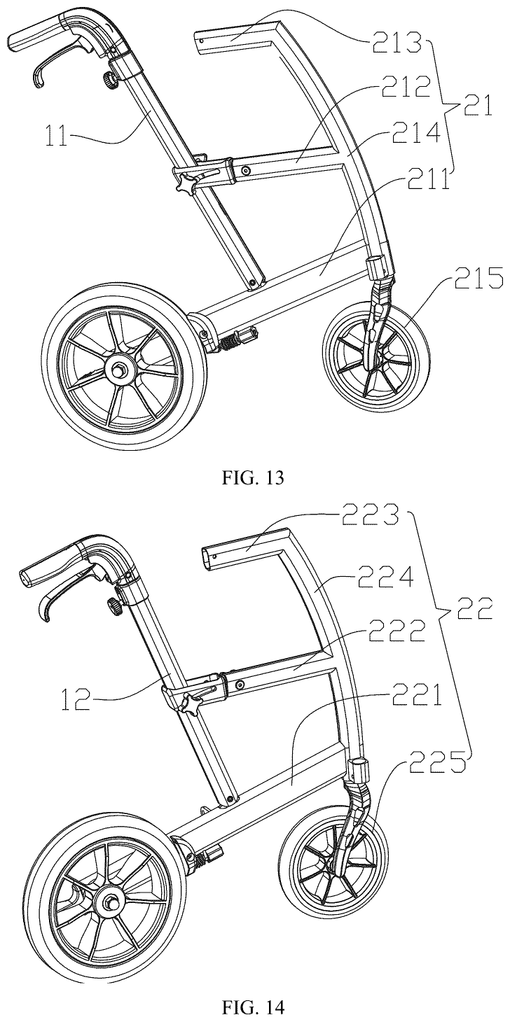

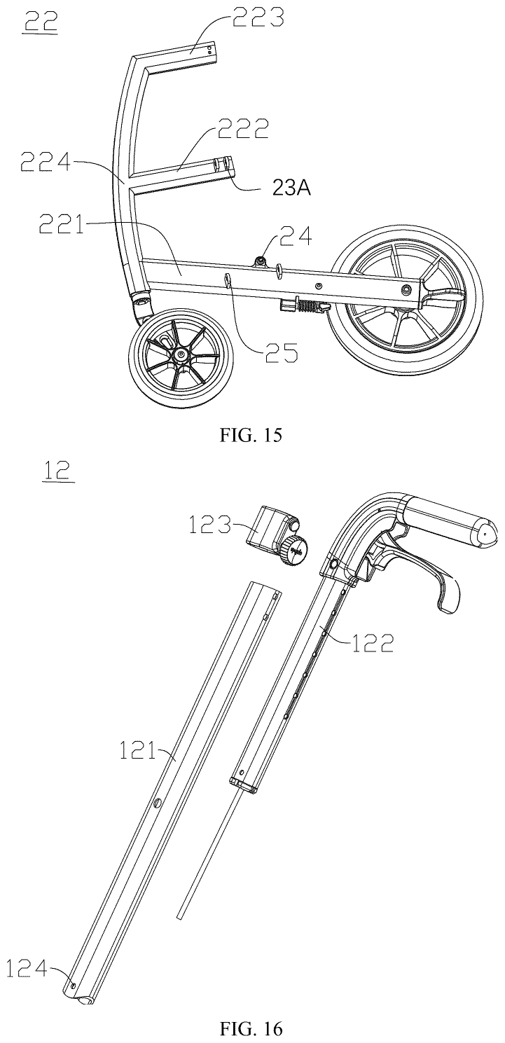

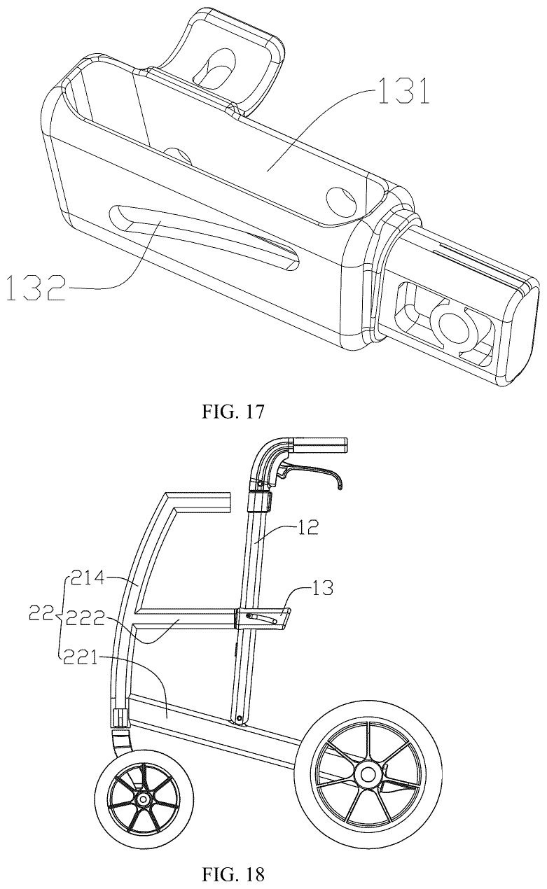

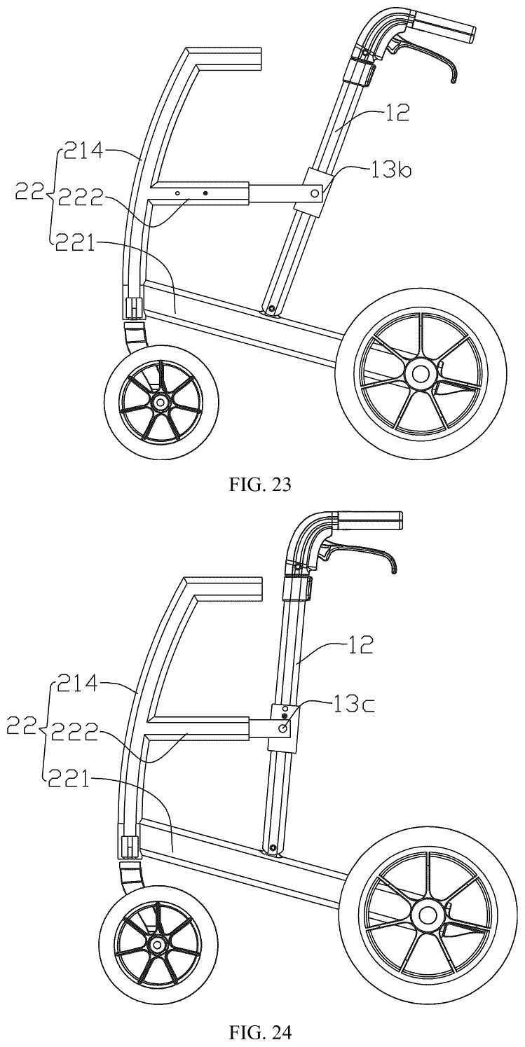

As shown in FIGS. 1 to 27, the present application provides a rollator comprising a frame body 100, a foot pedal assembly 300, a backrest assembly 400, and a seat cushion assembly 200, the seat cushion assembly 200 is installed on the frame body 100 for the user to sit on, and can switch from an assisted walking state to a wheelchair state according to the user's needs, that is, the rollator can switch wheelchair states to facilitate rest for people with limited mobility, relieve fatigue during movement, or push people with limited mobility sitting on the seat cushion assembly 200 to have a longer travel distance. The backrest assembly 400 is rotatably connected or detachably installed on the frame body 100 and located above the seat cushion assembly 200, for the user to rest and reduce fatigue. The foot pedal assembly 300 is rotatably connected or detachably installed on the frame body 100 for users to step on, improving the riding comfort of the rollator, and when not in use, it can also be rotated and retracted or disassembled relative to the frame body 100, saving space and effectively reducing collisions with obstacles during movement, making it convenient for the rollator to move.

In some embodiments, the frame body 100 comprises a frame body 20, and the frame body 20 includes a first frame 21, a second frame 22, and a connecting frame 23, the first frame 21 is connected to the second frame 22 through the connecting frame 23 and can be folded towards the second frame 22, so as to be folded when not in use, facilitating packaging, transportation, and storage. The seat cushion assembly 200 is disposed on the connecting frame 23, and the backrest assembly and foot pedal assembly 300 are both rotatably connected or detachably installed on the first frame 21 and the second frame 22, and the simple structure can easily exchange the unfolded and folded states, making it easy to carry with.

In an alternative embodiment, the connecting frame 23 includes a first cross bar 231 and a second cross bar 232 that are arranged crosswise and rotate relative to each other at the crosswise position, one end of the first cross bar 231 and the second cross bar 232 is connected to the first frame 21, the other end of the first cross bar 231 and the second cross bar 232 is connected to the second frame 22, and the two ends of the seat cushion assembly 200 are connected to the first cross bar 231 and the second cross bar 232, respectively, so that the first frame 21 and the second frame 22 can be unfolded or folded through the connecting frame 23.

Specifically, the connecting frame 23 further includes a first connecting block 233 and a second connecting block 234, both the first frame 21 and the second frame 22 are provided with a first connecting portion 23 and a second connecting portion 25, the middle of the first cross bar 231 and the second cross bar 232 is provided with a crosswise bar hinge point, and the first cross bar 231 and the second cross bar 232 are unfolded or folded around the crosswise bar hinge point. One end of the first cross bar 231 and the second cross bar 232 is rotatably connected to the second connecting portion 25, the other end of the first cross bar 231 is rotatably connected to the first connecting portion 23 through the first connecting block 233, and the other end of the second cross bar 232 or the position adjacent to the hinge point of the cross bar 232 is rotatably connected to the first connecting portion 23 through the second connecting block 234.

In the embodiment, the frame body 100 includes a handrail tube 10, the handrail tube 10 is rotatably connected to the first frame 21 and the second frame 22, so that users can use the handrail tube 10 to use the rollator, including auxiliary functions such as standing and walking. At the same time, the handrail tube 10 can be rotated and positioned relative to the first frame 21 and the second frame 22 to provide ergonomic operation convenience and ensure safety.

In an alternative embodiment, the handrail tube 10 includes a first handrail tube 11 and a second handrail tube 12, the first handrail tube 11 is rotatably connected to the first frame 21, and the second handrail tube 12 is rotatably connected to the second frame 22, both the first handrail tube 11 and the second handrail tube 12 have a first inclined state in which a first angle is formed with a support surface on which the frame body 100 is placed, and a second inclined state in which a second angle is formed with a support surface, the first angle is within the range of 80°-90°, and the second angle is within the range of 65°-75°.

The above technical solution can facilitate switching between and maintaining the first inclined state and the second inclined state for the first handrail tube 11 and the second handrail tube 12, so that the first handrail tube 11 and the second handrail tube 12 can be adjusted and positioned to achieve ergonomic operation convenience, making the rollator more user-friendly, and the first inclined state and the second inclined state can be switched according to the user's use situation, thereby improving the comfort of the rollator, enriching its functions, and relieving fatigue after use.

In an alternative embodiment, the first frame 21 includes a first support rod 211 having a first roller member 215, the second frame 22 includes a second support rod 221 having a second roller member 225, the first handrail tube 11 is rotatably connected to the middle of the first support rod 211, and the second handrail tube 12 is rotatably connected to the middle of the second support rod 221, so that Users can easily walk with the help of a rollator, while also ensuring the balance of the frame body 100.

Exemplarily, there are two first roller members 215 and two second roller members 225, the two first roller members 215 are correspondingly disposed at the two ends of the first support rod 211, the first handrail tube 11 is disposed between the two first roller members 215, the two second roller members 225 are correspondingly disposed at the two ends of the second support rod 221, and the second handrail tube 12 is disposed between the two second roller members 225.

In an alternative embodiment, the first frame 21 has a first adjusting member connecting to the first handrail tube 11 and the first frame 21 for switching the first handrail tube 11, when operated, between a first inclined state and a second inclined state, and specifically, settings can be made based on users' needs.

In an alternative embodiment, the second frame has a second adjusting member 22 connecting to the second handrail tube 12 and the second frame 22 for switching the second handrail tube 12, when operated, between the first inclined state and the second inclined state, and specifically, settings can be made based on users' needs.

It should be noted that the inclined state of the first handrail tube 11 relative to the first frame 21 is the same to that of the second handrail tube 12 relative to the second frame 22, facilitating the use of the rollator, that is, when the first handrail tube 11 is in the first inclined state, the second frame 22 also needs to be adjusted to the first inclined state through the second adjusting member. Similarly, when the first handrail tube 11 is in the second inclined state, the second frame 22 also needs to be adjusted to the second inclined state through the second adjusting member.

In an alternative embodiment, the first frame 21 includes a first spacer rod 212 that is spaced apart from the first support rod 211 along a height direction of the first frame 21, and the first handrail tube 11 is movably connected to the first spacer rod 212 through the first adjusting member, so that the first handrail tube 11 can adjust the angle between it and the first spacer rod 212 through the first adjusting member, thereby adjusting the angle between the first handrail tube 11 and the first support rod 211, that is, the first handrail tube 11 can switch between the first inclined state and the second inclined state, and specifically, adjustment can be made based on users' needs.

In an alternative embodiment, the second frame 22 includes a second spacer rod 222 that is spaced apart from the second support rod 222 along a height direction of the first frame 22, and the second handrail tube 12 is movably connected to the second spacer rod 222 through the second adjusting member, so that the angle between the second handrail tube 12 and the first support rod 211 is adjusted, that is, the second handrail tube 11 can switch between the first inclined state and the second inclined state, and specifically, adjustment can be made based on users' needs.

It should be noted that the second handrail tube 12 and the first handrail tube 11 may, after adjustment, have the same or different inclined state and specific adjustment can be made according to the user's needs, and the two are adjusted separately, so there is a certain error in the adjustment process. Therefore, the present application does not limit the inclined state of the second handrail tube 12 and the first handrail tube 11 after adjustment.

In an alternative embodiment, the first and second adjusting members have a first adjustment position and a second adjustment position, and when the first handrail tube 11 and second handrail tube 12 are fixed in the first adjustment position, the first handrail tube 11 and second handrail tube 12 are in a first inclined state; when the first handrail tube 11 and the second handrail tube 12 are fixed in the second adjustment position, the first handrail tube 11 and the second handrail tube 12 are in a second inclined state. The first and second adjustment positions can be two separate fixed parts on the first and second adjusting members, or can be any two positions on the sliding rails on the first and second adjusting members, and the first and second adjustment positions can even be two telescopic positions of the telescopic structure, which are not limited by the present application.

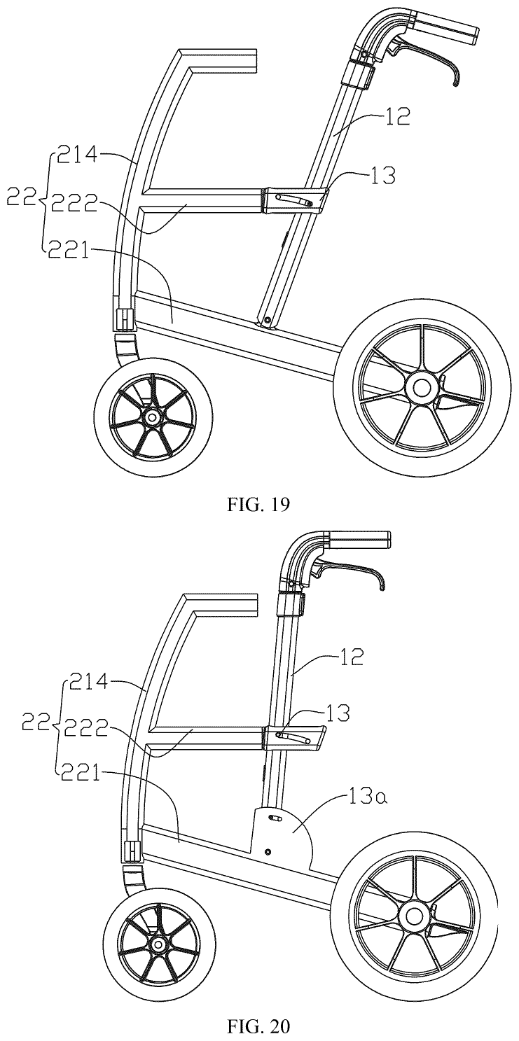

In an alternative embodiment, as shown in FIG. 1, FIG. 18 and FIG. 19, the first and second adjusting members include a connection structure 13 connecting to the first spacer rod 212 and second spacer rod 222, the connection structure 13 has the first adjustment position and second adjustment position that communicate with each other and form an adjustment track 132, and a limiting member is connected between the adjustment track 132 and the first handrail tubes and second handrail tube to restrict the first handrail tubes and second handrail tube to the first or second adjustment positions; or,

It should be noted that, the limiting member includes an adjusting screw that passes through the adjusting track and is connected to the first handrail tube 11 and the second handrail tube 12. When it is necessary to adjust the rotation angle of the first handrail tube 11 and the second handrail tube 12, the adjustment screw can be loosened so that the first handrail tube 11 and the second handrail tube 12 can move towards or away from the first spacer rod 212 and the second spacer rod 222; when the first handrail tube 11 and the second handrail tube 12 are adjusted to the first adjustment position or the second adjustment position, the adjustment screw can be tightened so that the first handrail tube 11 and the second handrail tube 12 can be fixed in the first adjustment position or the second adjustment position, and the inclined state of the first handrail tube 11 and the second handrail tube 12 can be regulated.

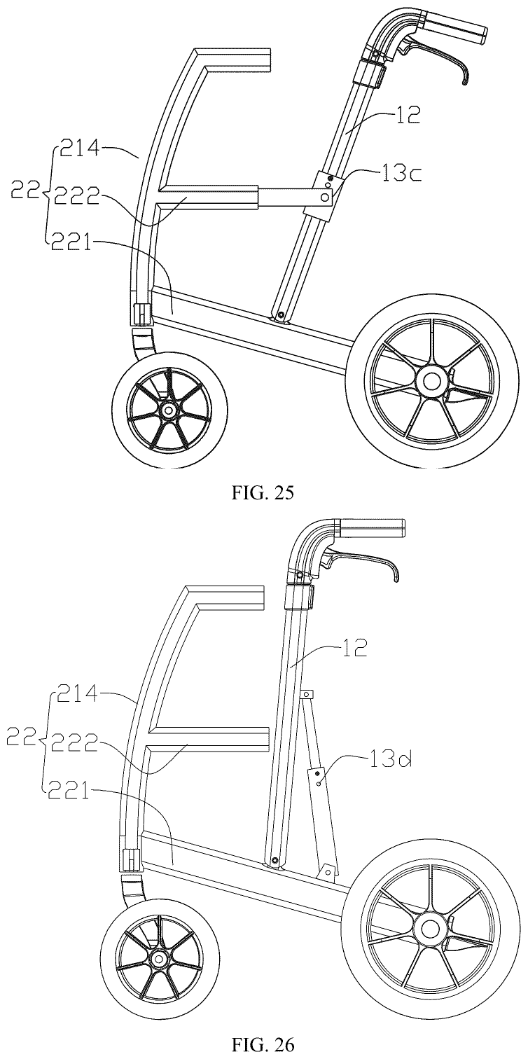

In an alternative embodiment, as shown in FIG. 1, FIG. 22 and FIG. 25, the first adjusting member and second adjusting member include a telescopic rod 13b, one end of the telescopic rod 13b is connected to the first spacer rod 11 and second spacer rod 12, a sliding sleeve structure is provided between the telescopic end of the telescopic rod 13b and the first handrail tube 11 and second handrail tube 12, and the sliding sleeve structure slides along a length direction of the first handrail tube 11 and second handrail tube 12 under the action of the telescopic rod 13b, used to adjust the distance between the first handrail tube 11 and the second handrail tube 12 relative to the first spacer rod 212 and the second spacer rod 222.

Exemplarily, when the telescopic rod 13b is in the contracted state, that is, the first adjustment position, the sliding sleeve structure is located at one of the positions of the first handrail tube 11 and the second handrail tube 12, and the first handrail tube 11 and the second handrail tube 12 are in the first inclined state; when the telescopic rod 13b is in the extended state, that is, the second adjustment position, the sliding sleeve structure slides along the first handrail tube 11 and the second handrail tube 12 towards the side away from the first support rod 211 and the second support rod 221, and the first handrail tube 11 and the second handrail tube 12 are in the second inclined state.

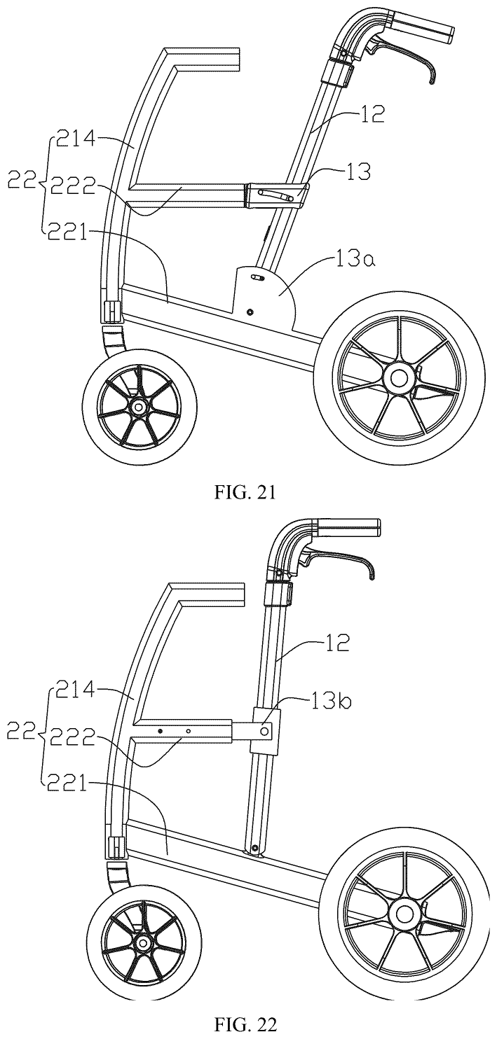

In an alternative embodiment, as shown in FIG. 1, FIG. 20 and FIG. 21, the first adjusting member and second adjusting member include a rotating table 13a connecting to the first support rod 211 and second support rod 221, the rotating table 13a has a rotating track, and the first handrail tube 11 and second handrail tube 12 are rotatably connected to the rotating table 13a and move along the rotating track; the rotating track can be used to limit the rotation angle of the first handrail tube 11 and the second handrail tube 12 relative to the first support rod 211 and the second support rod 221; at the same time, the rotating track can also cooperate with the limit pieces on the first handrail tube 11 and the second handrail tube 12 to firmly connect the first handrail tube 11 and second handrail tube 12 to the first frame 21 and second frame 22.

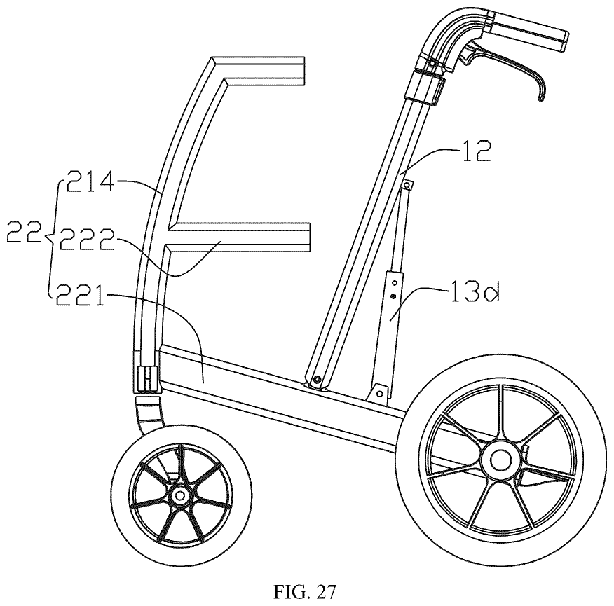

In an alternative embodiment, as shown in FIG. 1, FIG. 25 and FIG. 27, the first adjusting member and second adjusting member include a telescopic tube 13d, one end of the telescopic tube 13d is movably connected to the first handrail tube 11 and second handrail tube 12, and the other end of the telescopic tube 13d is movably connected to the first support rod 211 and second support rod 221 and has a preset distance greater than zero from the pivot point of the first handrail tube 11 and second handrail tube 12.

Exemplarily, as shown in FIG. 1 to FIG. 27, the first handrail tube 11 includes a first handrail portion, a first handrail rod, and a first fixed portion, the opposite ends of first handrail rod are provided with a first mounting portion and a second rotating portion, respectively, the first handrail portion is disposed on the first mounting portion and adjusts its length extending out of the first handrail rod through the first fixed portion, and the first rotating portion is rotatably mounted on a rotating connection portion 24 on the first support rod 211.

In this embodiment, the second handrail tube 12 has the same structure as the first handrail tube 11, and includes a second handrail portion 122, a second handrail rod 121, and a second fixed portion 123, and the opposite ends of second handrail rod are provided with a second mounting portion and a second rotating portion 124, respectively, the second handrail portion 122 is disposed on the second mounting portion and adjusts its length extending out of the second handrail rod 121 through the second fixed portion 123, and the second rotating portion 124 is rotatably mounted on a rotating connection portion 24 on the second support rod 221.

In an alternative embodiment, the foot pedal assembly 300 includes a foot pedal 301 and a foot pedal support 302, the foot pedal support 302 has a first section 3021, a second section 3022, and a third section 3023, the first section 3021 and the second section 3022 are arranged at a predetermined angle at the two ends of the third connecting section 3023, the foot pedal 301 is rotatably connected to the first section 3021, and the second section 3022 is rotatably connected to one end of the first support rod 211 adjacent to the first roller member 215 and one end of the second support rod 222 adjacent to the second roller member 225.

Exemplarily, the foot pedal assembly 300 includes a first foot pedal assembly, and the first foot pedal assembly comprises a first foot pedal and a first foot pedal support, the first foot pedal support has a first connecting section, a second connecting section, and a third connecting section; the first connecting section and the second connecting section are arranged at a predetermined angle at the two ends of the third connecting section, the first foot pedal is rotatably connected to the first connecting section, and the second connecting section is rotatably connected to one end of the first support rod adjacent to the first roller member.

Exemplarily, the foot pedal assembly 300 includes a second foot pedal assembly, and the second foot pedal assembly comprises a second foot pedal and a second foot pedal support, the second foot pedal support has a first jointing section, a second jointing section, and a third jointing section; the first jointing section and the second jointing section are arranged at a predetermined angle at the two ends of the third jointing section, the second foot pedal is rotatably connected to the first jointing section, and the second jointing section is rotatably connected to one end of the second support rod adjacent to the second roller member.

In the embodiment, the foot pedal assembly 300 further includes a foot pedal adjustment block 304 and a foot pedal adjustment rod 305, foot pedal adjustment holes are spaced apart on the first section 3021, the foot pedal adjustment block 304 runs through the first section 3021, and the foot pedal adjustment rod 305 runs through the foot pedal adjustment block 304 and the foot pedal adjustment hole and is rotatably connected to the foot pedal 301 for adjusting the height of the foot pedal 301 on the first section 3021 to adapt to the height of foot pedal.

The foot pedal assembly 300 further includes a foot pedal rotating sleeve 303, the second section 3022 is rotatably connected to the first support rod 211 and the second support rod 222, and the foot pedal rotating sleeve 303 is connected between the second section 3022 and the first support rod 211, as well as between the second section 3022 and the second support rod 222, so that the foot pedal 301 can smoothly retract from the unfolded state, relative to the first frame 21 and the second frame 22, to the folded state.

In an alternative embodiment, the first frame 21 includes a first connecting rod 213 spaced apart from the first spacer rod 212 in a height direction, the second frame 22 includes a second connecting rod 223 spaced apart from the second spacer rod 222 in a height direction, and the backrest assembly 400 is rotatably connected between the first connecting rod 213 and the second connecting rod 223.

Exemplarily, the first frame 21 includes a first jointing rod 214, the second frame 22 includes a second jointing rod 224, and the first connecting rod 213, the first spacer rod 212, and the first support rod 211 are spaced apart along a height direction of the first jointing rod 214, and the second connecting rod 223, the second spacer rod 333, and the second support rod 221 are spaced apart along a height direction of the second jointing rod 224.

The first jointing rod 214 has the same structure as the second jointing rod 224 and has an arc-shaped bending shape, the first connecting rod 213 and the first support rod 211 are arranged at the two ends of the first jointing rod 214, the second connecting rod 223 and the second support rod 222 are arranged at the two ends of the second jointing rod 224, and the backrest assembly 400 is rotatably connected to the first connecting rod 213 and the second connecting rod 223, used to adjust the orientation of the backrest assembly 400, so that users in a wheelchair state can lean on the backrest assembly 400, and face the other side when not in a wheelchair state, to free up enough space to assist in standing.

In an alternative embodiment, the backrest assembly 400 has an arc-shaped rear surface 401, and the two ends of the rear surface 401 are rotatably connected to the first connecting rod 213 and the second connecting rod 223, respectively, and the concave depth of the rear surface 401 fits the length of the first connecting rod 213 and the second connecting rod 223, that is, when the backrest 30 rotates from one direction to another, the rear surface 31 does not protrude from the first connecting rod 213 and the second connecting rod 223, while ensuring a sufficient arc for the user to rely on.

In the embodiment, the backrest assembly 400 includes a backrest connection portion 402, and the two ends of the rear surface 401 are respectively connected to the first connecting rod 213 and the second connecting rod 223 through the backrest connection portion 402.

It should be noted that the first connecting rod 213 and the second connecting rod 223 have arc-shaped structures, one end of the arc-shaped structure is connected to the first jointing rod 214 and the second jointing rod 224, and the two ends of the rear surface 401 are connected to the other end of the arc-shaped structure, and the depth of the rear surface 401 fits the minimum distance between the farthest and closest ends of the arc-shaped structure.

In addition, the two ends of the backrest assembly 400 can also be connected to the second handrail tube 12 and the first handrail tube 11, that is, the first connecting rod 213 and the second connecting rod 223 is unnecessarily to be provided on the first frame 21 and the second frame 22.

In an alternative embodiment, the seat cushion assembly 200 includes a seat cushion 201 and a storage structure 202, and the storage structure 202 is connected to the seat cushion 201, and the seat cushion and storage structure are made of woven fabric material. The seat cushion 201 is fixed on the first cross bar 231 and the second cross bar 232, and a handle is provided on the seat cushion 201 to enable the fast folding of the rollator.

In an alternative embodiment, the first roller member 215 includes a first front wheel and a first rear wheel, the first front wheel and the first rear wheel are respectively arranged at the two ends of the first support rod 211, and the diameter of the first rear wheel is greater than or equal to that of the first front wheel; and/or,

In an alternative embodiment, the second roller member 225 includes a second front wheel and a second rear wheel, the second front wheel and second rear wheel are respectively arranged at the two ends of the second support rod 221, and the diameter of the second rear wheel is greater than or equal to that of the second front wheel.

It should be noted that in the description of the present application, unless otherwise specified and limited, the terms “installation”, “connected”, and “connection” should be broadly understood, for example, can be fixed connection, detachable connection, or integral connection; can be mechanical connection or electrical connection; can be direct connection, indirect connection through an intermediate medium, or internal connection between two components. The person having ordinary skill in the art can understand the specific meanings of the above terms in the present application in specific situations.

In the present application, unless otherwise specified and limited, the first feature being “above” or “below” the second feature may include direct contact between the first and second features, or may include the contact between the first and second features through another feature instead of direct contact. Moreover, the first feature being ‘on’, ‘above’, and ‘over’ the second feature includes the first feature being directly above and diagonally above the second feature, or simply indicating that the first feature is horizontally higher than the second feature. The first feature being “under”, “below”, and “underneath” the second feature include the first feature being directly below and diagonally below the second feature, or simply indicating that the first feature has a lower horizontal height than the second feature.

The above disclosure provides many different embodiments or examples to implement the different structures of the present application. In order to simplify the disclosure of the present application, the components and settings of specific examples are described in the preceding text and, of course, they are only examples and are not intended to limit the scope of the present application. In addition, the present application may repeat reference numbers and/or reference letters in different examples for the purpose of simplification and clarity, and does not in itself indicate the relationship between the various embodiments and/or settings discussed. In addition, the present application provides examples of various specific processes and materials, but those of ordinary skill in the art may be aware of the application of other processes and/or the use of other materials.

In the description of the present specification, the reference to the terms “one embodiment”, “some embodiments”, “illustrative embodiments”, “examples”, “specific examples”, or “some examples” means that the specific features, structures, materials, or characteristics described in conjunction with the embodiments or examples are included in at least one embodiment or example of the present application. In the specification, the illustrative expressions of the above terms may not necessarily refer to the same implementation or examples. Moreover, the specific features, structures, materials, or characteristics described can be combined in any one or more embodiments or examples in an appropriate manner.

### INDUSTRIAL APPLICABILITY

A rollator, wherein comprising a frame body, a foot pedal assembly, a backrest assembly, and a seat cushion assembly; the frame body comprises a first frame, a second frame, and a connecting frame, the seat cushion assembly is disposed on the connecting frame, the first frame is connected to the second frame through the connecting frame and is folded towards the second frame, the foot pedal assembly is rotatably connected or detachably installed on the first frame and the second frame, and is below the connecting frame, and the backrest assembly is rotatably connected or detachably installed on the first frame and the second frame, and is above the connecting frame;

the first frame is rotatably connected with a first handrail tube, and the second frame is rotatably connected with a second handrail tube, both the first handrail tube and the second handrail tube have a first inclined state in which a first angle is formed with a support surface on which the frame is placed, and a second inclined state in which a second angle is formed with a support surface, the first angle is within the range of 80°-90°, and the second angle is within the range of 65°-75°.

The present application designs a rollator, comprising a frame, a foot pedal assembly, and a seat cushion assembly, the frame is rotatably connected with a first handrail tube and a second handrail tube, so that the first handrail tube and the second handrail tube can, relative to the frame, switch and be fixed in the first inclined state and the second inclined state, such that the rollator has different use states to meet the various needs of users, make users feel comfortable and satisfied and operate the first handrail tube and the second handrail tube more conveniently, thereby improving the user experience.

What is claimed is:

1. A rollator, comprising a frame body, a foot pedal assembly, a backrest assembly, and a seat cushion assembly; the frame body comprises a first frame, a second frame, and a connecting frame, the seat cushion assembly is disposed on the connecting frame, the first frame is connected to the second frame through the connecting frame and is folded towards the second frame, the foot pedal assembly is rotatably connected or detachably installed on the first frame and the second frame, and is below the connecting frame, and the backrest assembly is rotatably connected or detachably installed on the first frame and the second frame, and is above the connecting frame;
wherein the first frame is rotatably connected with a first handrail tube, and the second frame is rotatably connected with a second handrail tube, both the first handrail tube and the second handrail tube have a first inclined state in which a first angle is formed with a support surface on which the frame is placed, and a second inclined state in which a second angle is formed with a support surface;
wherein the first frame comprises a first support rod having a first roller member, the second frame comprises a second support rod having a second roller member, the first handrail tube is rotatably connected to the middle of the first support rod, and the second handrail tube is rotatably connected to the middle of the second support rod;
the first frame has a first adjusting member connecting to the first handrail tube for switching the first handrail tube, when operated, between a first inclined state and a second inclined state; and/or,
the second frame has a second adjusting member connecting to the second handrail tube for switching the second handrail tube, when operated, between the first inclined state and the second inclined state.

2. The rollator of claim 1, wherein the connecting frame comprises a first connecting block, a second connecting block, a first cross bar and a second cross bar that are arranged crosswise and rotate relative to each other at the crosswise position, the two ends of the first cross bar and the second cross bar are connected to the first frame and the second frame respectively, and the two ends of the seat cushion assembly are connected to the first cross bar and the second cross bar respectively.

3. The rollator of claim 2, wherein the middle of the first cross bar and the second cross bar is provided with a crosswise bar hinge point, and the first cross bar and the second cross bar are unfolded or folded around the crosswise bar hinge point.

4. The rollator of claim 3, wherein both the first frame and the second frame are provided with a first connecting portion and a second connecting portion, one end of the first cross bar and the second cross bar is rotatably connected to the second connecting portion, the other end of the first cross bar is rotatably connected to the first connecting portion through the first connecting block, and the other end of the second cross bar is rotatably connected to the first connecting portion through the second connecting block.

5. The rollator of claim 1, wherein there are two first roller members and two second roller members, the two first roller members are correspondingly disposed at the two ends of the first support rod, the first handrail tube is disposed between the two first roller members, the two second roller members are correspondingly disposed at the two ends of the second support rod, and the second handrail tube is disposed between the two second roller members.

6. The rollator of claim 5, wherein the inclined state of the first handrail tube relative to the first frame is the same to that of the second handrail tube relative to the second frame.

7. The rollator of claim 1, wherein the first frame comprises a first spacer rod that is spaced apart from the first support rod along a height direction of the first frame, and the first handrail tube is movably connected to the first spacer rod through the first adjusting member.

8. The rollator of claim 1, wherein the second frame comprises a second spacer rod that is spaced apart from the second support rod along a height direction of the first frame, and the second handrail tube is movably connected to the second spacer rod through the second adjusting member.

9. The rollator of claim 7, wherein the first and second adjusting members each has a first adjustment position and a second adjustment position, and when the first handrail tubes and second handrail tube are fixed in the first adjustment position, the first handrail tubes and second handrail tube are in a first inclined state; when the first handrail tube and the second handrail tube are fixed in the second adjustment position, the first handrail tube and the second handrail tube are in a second inclined state.

10. The rollator of claim 9, wherein the first and second adjusting members comprise a connection structure connecting to the first spacer rod and second spacer rod, the connection structure has the first adjustment position and second adjustment position that communicate with each other and form an adjustment track, and a limiting member is connected between the adjustment track and the first handrail tubes and second handrail tube to restrict the first handrail tubes and second handrail tube to the first or second adjustment positions.

11. The rollator of claim 9, wherein the first adjusting member and second adjusting member comprise a telescopic rod, one end of the telescopic rod is connected to the first spacer rod and second spacer rod, a sliding sleeve structure is provided between the telescopic end of the telescopic rod and the first handrail tube and second handrail tube, and the sliding sleeve structure slides along a length direction of the first handrail tube and second handrail tube under the action of the telescopic rod.

12. The rollator of claim 10, wherein the limiting member comprises an adjusting screw that passes through the adjusting track and is connected to the first handrail tube and the second handrail tube.

13. The rollator of claim 1, wherein the first adjusting member and second adjusting member comprise a rotating table connecting to the first support rod and second support rod, the rotating table has a rotating track, and the first handrail tube and second handrail tube are rotatably connected to the rotating table and move along the rotating track; and/or,
the first adjusting member and second adjusting member comprise a telescopic tube, one end of the telescopic tube is movably connected to the first handrail tube and second handrail tube, and the other end of the telescopic tube is movably connected to the first support rod and second support rod and has a preset distance greater than zero from the pivot point of the first handrail tube and second handrail tube.

14. The rollator of claim 13, wherein the first handrail tube comprises a first handrail portion, a first handrail rod, and a first fixed portion, the opposite ends of first handrail rod are provided with a first mounting portion and a first rotating portion, respectively, the first handrail portion is disposed on the first mounting portion and adjusts its length extending out of the first handrail rod through the first fixed portion, and the first rotating portion is rotatably mounted on a rotating connection portion on the first support rod; wherein the second handrail tube has the same structure as the first handrail tube.

15. The rollator of claim 1, wherein the first frame comprises a first connecting rod spaced apart from the first spacer rod in a height direction, the second frame comprises a second connecting rod spaced apart from the second spacer rod in a height direction, and the backrest assembly is rotatably connected between the first connecting rod and the second connecting rod.

16. The rollator of claim 15, wherein the first frame comprises a first jointing rod, the second frame comprises a second jointing rod, and the first connecting rod, the first spacer rod, and the first support rod are spaced apart along a height direction of the first jointing rod, and the second connecting rod, the second spacer rod, and the second support rod are spaced apart along a height direction of the second jointing rod.

17. The rollator of claim 16, wherein the first jointing rod has the same structure as the second jointing rod and has an arc-shaped bending shape, the first connecting rod and the first support rod are arranged at the two ends of the first jointing rod, the second connecting rod and the second support rod are arranged at the two ends of the second jointing rod, and the backrest assembly is rotatably connected to the first connecting rod and the second connecting rod.

18. The rollator of claim 16, wherein the backrest assembly comprises a backrest connecting portion and has an arc-shaped rear surface, and the two ends of the rear surface are rotatably connected to the first connecting rod and the second connecting rod through the backrest connecting portion, respectively, and the concave depth of the rear surface fits the length of the first connecting rod and the second connecting rod;
wherein the first connecting rod and the second connecting rod have arc-shaped structures, one end of the arc-shaped structure is connected to the first connecting rod and the second connecting rod, and the two ends of the rear surface are connected to the other end of the arc-shaped structure;
the depth of the rear surface fits the minimum distance between the farthest and closest ends of the arc-shaped structure.

19. The rollator of claim 2, wherein the foot pedal assembly comprises a foot pedal, a foot pedal support, a foot pedal adjustment block, a foot pedal adjustment rod, and a foot pedal rotating sleeve the foot pedal support has a first section, a second section, and a third section, the first section and the second section are arranged at a predetermined angle at the two ends of the third section, the foot pedal is rotatably connected to the first section, and the second section is rotatably connected to one end of the first support rod adjacent to the first roller member and one end of the second support rod adjacent to the second roller member;
foot pedal adjustment holes are spaced apart on the first section, the foot pedal adjustment block runs through the first section, and the foot pedal adjustment rod runs through the foot pedal adjustment block and the foot pedal adjustment hole and is rotatably connected to the foot pedal for adjusting the height of the foot pedal on the first section;
the second section is rotatably connected to the first support rod and the second support rod, and the foot pedal rotating sleeve is connected between the second section and the first support rod, as well as between the second section and the second support rod; and/or,
the foot pedal assembly comprises a second foot pedal assembly, and the second foot pedal assembly has the same structure as the foot pedal assembly.

20. The rollator of claim 1, wherein the first roller member comprises a first front wheel and a first rear wheel, the first front wheel and the first rear wheel are respectively arranged at the two ends of the first support rod, and the diameter of the first rear wheel is greater than or equal to that of the first front wheel; and/or,
the second roller member comprises a second front wheel and a second rear wheel, the second front wheel and second rear wheel are respectively arranged at the two ends of the second support rod, and the diameter of the second rear wheel is greater than or equal to that of the second front wheel.
